(19) United States
(12) Patent Application Publication
(10) Pub. No.: US 2005/0024997 A1
(43) Pub. Date: Feb. 3, 2005

(54) Optical recording disk device and manufacturing method therefor

(75) Inventor: Tatsuki Wade, Suwa-gun (JP)

Correspondence Address: HOGAN & HARTSON L.L.P., 500 S. GRAND AVENUE, SUITE 1900, LOS ANGELES, CA, 90071-2611, US

(73) Assignee: SANKYO SEIKI MFG. CO., LTD.

(21) Appl. No.: 10/890,809

(22) Filed: Jul. 14, 2004

(30) Foreign Application Priority Data
Jul. 16, 2003 (JP) 2003-275198

(51) Int. Cl. G11B 7/00

(52) U.S. Cl. 369/44.22; 369/44.15; 369/44.32

(57) ABSTRACT

An optical recording disk device includes an optical head mechanism provided with an optical system for converging an emitted light beam from a light source on an optical recording disk, a frame to which the optical head mechanism is mounted, two guide shafts for guiding the frame in a radial direction of the optical recording disk, a disk drive mechanism provided with a turntable for holding the optical recording disk and a chassis to which the frame, the two guide shafts and the disk drive mechanism are mounted. At least one of the two guide shafts is constructed such that the inclination of one of the two guide shafts is unable to be adjusted and fixed with respect to the chassis in an optical axis direction toward the optical recording disk.

### FIELD OF THE INVENTION

The present invention relates to an optical recording disk device that is used for reproduction or the like of an optical recording disk such as a CD or a DVD and relates to a manufacturing method for the optical recording disk device.

### BACKGROUND OF THE INVENTION

An optical recording disk device which is used for recording onto or reproducing from an optical record disk such as a CD or a DVD includes an optical head mechanism provided with an optical system for converging an emitted light beam from a light source into an optical recording disk, a frame on which the optical head mechanism is mounted, two guide shafts for guiding the frame in the radial direction of the optical record disk, a disk drive mechanism provided with a turntable on which the optical record disk is held, and a chassis to which the frame, the two guide shafts and the disk drive are mounted.

In the optical recording disk drive, the laser beam that is emitted from the optical head mechanism is required to be guided and condensed perpendicularly on the optical recording disk supported on the turntable. Therefore, the conventional optical head mechanism is constructed on the frame so as to be adjustably inclined and the inclination adjustment of the optical head mechanism with respect to the frame is performed. The disk drive mechanism and the two guide shafts are adjustably constructed on the chassis in an inclination direction. Accordingly, the disk drive mechanism is adjusted in the inclination direction such that the rotary shaft of a spindle motor is perpendicular to the chassis and then the disk drive mechanism is fixed on the chassis. Further, the optical head mechanism is adjusted with respect to the frame in the inclination direction and fixed on the frame. The frame is carried on the two guide shafts. And, at the time of final adjustment, the respective inclinations of the two guide shafts are adjusted such that the inclination of the optical axis is finally adjusted to obtain the maximum jitter characteristics or the like while an optical recording disk is rotated on the turntable and a laser beam is emitted from the optical head mechanism.

However, as the conventional method, in order that the inclinations of the two guide shafts are adjusted on the chassis to adjust the inclination of the optical axis of a laser beam with respect to the optical recording disk which rotates on the turntable in the final adjustment, it is necessary to arrange the two guide shafts on the chassis beforehand such that the inclinations of the two guide shafts are capable of adjusting in a wide range. Therefore, in this conventional method, when the inclinations of the two guide shafts are adjusted, the frame supported by the two guide shafts also inclines to a large extent, and thus a wide space for adjustment is required between the frame and a lower cover disposed under the frame, which results in being unable to reduce the thickness of the optical recording disk device.

### SUMMARY OF THE INVENTION

In view of the problems described above, it is an advantage of the present invention to provide an optical recording disk device in which the inclination of the optical axis of a laser beam emitted from an optical head mechanism can be adjusted with respect to an optical recording disk rotated on a turntable and which is capable of reducing its thickness, and to provide a manufacturing method for the optical recording disk device.

In order to achieve the above advantage, according to the present invention, there is provided an optical recording disk device including an optical head mechanism provided with an optical system for converging an emitted light beam from a light source on an optical recording disk, a frame to which the optical head mechanism is mounted, two guide shafts for guiding the frame in a radial direction of the optical recording disk, a disk drive mechanism provided with a turntable for holding the optical recording disk, and a chassis to which the frame, the two guide shafts and the disk drive mechanism are mounted. At least one of the two guide shafts is constructed such that the inclination of the one of the guide shafts is unable to be adjusted and fixed with respect to the chassis in an optical axis direction toward the optical recording disk.

In accordance with an embodiment of the present invention, an adjusting mechanism of the parallelism between the two guide shafts may be constructed between one of two guide shafts and the chassis, by which the parallelism of one of the guide shafts is adjusted, but an adjusting mechanism is not constructed for the other of the guide shafts to adjust its inclination in an optical axial direction. Also, in accordance with an embodiment of the present invention, no inclination adjustment mechanism may be constructed on both the two guide shafts.

According to a manufacturing method for an optical recording disk device in accordance with an embodiment of the present invention, two guide shafts for mounting the frame are fixed on the chassis and the disk drive mechanism is mounted to the chassis and then the inclination adjustment of the optical head mechanism is performed with the turntable of the disk drive mechanism as a reference. After that, the optical head mechanism is mounted to the frame. In this case, after the frame is mounted to the two guide shafts, the two guide shafts may be fixed to the chassis, or the frame may be mounted to the two guide shafts after the two guide shafts are fixed to the chassis.

In accordance with an embodiment of the present invention, the disk drive mechanism is mounted to the chassis and then the inclination adjustment of the optical head mechanism is performed with the turntable of the disk drive mechanism as a reference and then the optical head mechanism is mounted to the frame. Therefore, the inclination of the optical axis of a laser beam emitted from the optical head mechanism is directly adjusted with respect to the optical recording disk which rotates on the turntable and thus, the inclination adjustment of two guide shafts are not required. Accordingly, a wide clearance is not required in order to ensure the displacement of the frame when the inclinations of the two guide shafts are adjusted as with the conventional method. Consequently, the thickness of the optical recording disk device can be reduced. Also, the chassis is not required to be provided with an inclination adjustment mechanism for the two guide shafts in the optical axis direction toward the optical recording disk and thus the construction of the chassis can be simplified.

According to another manufacturing method for an optical recording disk device in accordance with an embodiment of the present invention, two guide shafts for mounting the frame are fixed on the chassis and the optical head mechanism is mounted to the frame and then the inclination adjustment of the disk drive mechanism is performed with the optical head mechanism as a reference. After that, the disk drive mechanism is mounted to the chassis.

In accordance with an embodiment of the present invention, the optical head mechanism is mounted to the two guide shafts via the frame and then an inclination adjustment of the disk drive mechanism is performed with the optical head mechanism as a reference and then the disk drive mechanism is mounted to the chassis. Therefore, the inclination of the optical axis of a laser beam emitted from the optical head mechanism is directly adjusted with respect to the optical recording disk which rotates on the turntable and thus, the inclination adjustment of the two guide shafts are not required. Accordingly, a wide clearance is not required in order to ensure the displacement of the frame when the inclinations of the two guide shafts are adjusted as with the conventional method. Consequently, the thickness of the optical recording disk device is reduced. Also, the chassis is not required to be provided with an inclination adjustment mechanism for two guide shafts in the optical axis direction toward the optical recording disk and thus the construction of the chassis can be simplified.

According to further another manufacturing method for an optical recording disk device in accordance with an embodiment of the present invention, after two guide shafts for mounting the frame are fixed to the chassis, an inclination adjustment of the disk drive mechanism is performed with the guide shaft as a reference and then the disk drive mechanism is mounted to the chassis. Further, the inclination adjustment of the optical head mechanism is performed with the turntable or the guide shaft as a reference and then the optical head mechanism is mounted to the frame.

In accordance with an embodiment of the present invention, after the inclination adjustment of the disk drive mechanism is performed with the guide shaft as a reference, the disk drive mechanism is mounted to the chassis. Therefore, even when the inclination adjustment of the optical head mechanism is performed with the turntable or the guide shaft as a reference, the inclination of the optical axis of a laser beam emitted from the optical head mechanism can be adjusted with respect to the optical recording disk which rotates on the turntable and thus, the inclination adjustment of the two guide shafts are not required. Accordingly, a wide clearance is not required in order to ensure the displacement of the frame when the inclinations of two guide shafts are adjusted as with the conventional method. Consequently, the thickness of the optical recording disk device is reduced. Also, the chassis is not required to be provided with an inclination adjustment mechanism for two guide shafts in the optical axis direction toward the optical recording disk and thus the construction of the chassis can be simplified.

According to a further manufacturing method for an optical recording disk device in accordance with an embodiment of the present invention, after two guide shafts for mounting the frame are fixed to the chassis, the inclination adjustment of the optical head mechanism is performed with the guide shaft as a reference and then the optical head mechanism is mounted to the frame. Further, the inclination adjustment of the disk drive mechanism is performed with the optical head mechanism or the guide shaft as a reference and then the disk drive mechanism is mounted to the chassis.

In accordance with an embodiment of the present invention, the inclination adjustment of the optical head mechanism is performed with the guide shaft as a reference and then the optical head mechanism is mounted to the frame. Therefore, even when the inclination adjustment of the disk drive mechanism is performed with the guide shaft or the optical head mechanism as a reference, the inclination of the optical axis of a laser beam emitted from the optical head mechanism can be adjusted with respect to the optical recording disk which rotates on the turntable and thus, the inclination adjustment of the two guide shafts are not required. Accordingly, a wide clearance is not required in order to ensure the displacement of the frame when the inclinations of two guide shafts are adjusted as with the conventional method. Consequently, the thickness of the optical recording disk device is reduced. Also, the chassis is not required to be provided with an inclination adjustment mechanism for two guide shafts in the optical axis direction toward the optical recording disk and thus the construction of the chassis can be simplified.

In accordance with an embodiment of the present invention, the optical head mechanism is preferably provided with an objective lens drive mechanism of a wire suspension type. The objective lens drive mechanism is provided with a lens holder that holds an objective lens and is movably supported by a plurality of wires in a focusing direction and a tracking direction.

Preferably, in accordance with an embodiment of the present invention, the height dimension of the optical system excluding the objective lens is substantially equal to the thickness dimension of the frame.

Preferably, in accordance with an embodiment of the present invention, the optical head mechanism is provided with an optical module in which a plurality of optical elements constructing the optical system are modularized. According to the construction described above, since the adjustment of the optical axis of individual optical elements is not required, the adjustment of the optical axis in the optical head device is easy.

According to the optical recording disk device of the present invention, the inclination of the optical axis of a laser beam emitted from the optical head mechanism can be adjusted with respect to the optical recording disk that rotates on the turntable without adjusting the inclinations of the two guide shafts. Accordingly, a wide clearance is not required in order to ensure the displacement of the frame when the inclinations of two guide shafts are adjusted as with the conventional method. Consequently, the thickness of the optical recording disk device is reduced. Also, the chassis is not required to be provided with an inclination adjustment mechanism for two guide shafts in the optical axis direction toward the optical recording disk and thus the construction of the chassis can be simplified.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

FIG. 1(A) is an explanatory perspective view showing an essential portion of an optical recording disk device in accordance with an embodiment of the present invention and FIG. 1(B) is an explanatory perspective view showing a frame to which an optical head mechanism is mounted in the optical recording disk device shown in FIG. 1(A).

FIG. 2 is an explanatory view showing a schematic longitudinal cross section of the optical recording disk device shown in FIG. 1.

FIG. 3 is an explanatory perspective view schematically showing an optical module that is used in the optical recording disk device shown in FIG. 1.

FIGS. 4(A) through 4(D) are explanatory views respectively showing steps to perform the inclination adjustment of the optical head device with the turntable of a disk drive mechanism as a reference in a manufacturing method for the optical recording disk device in accordance with an embodiment of the present invention.

### DETAILED DESCRIPTION OF THE PREFERRED EMBODIMENTS

Optical recording disk devices in accordance with embodiments of the present invention will be described below in detail with reference to the accompanying drawings. First, the common construction of the respective embodiments will be described prior to describing the respective embodiments of the present invention.

Common Construction.

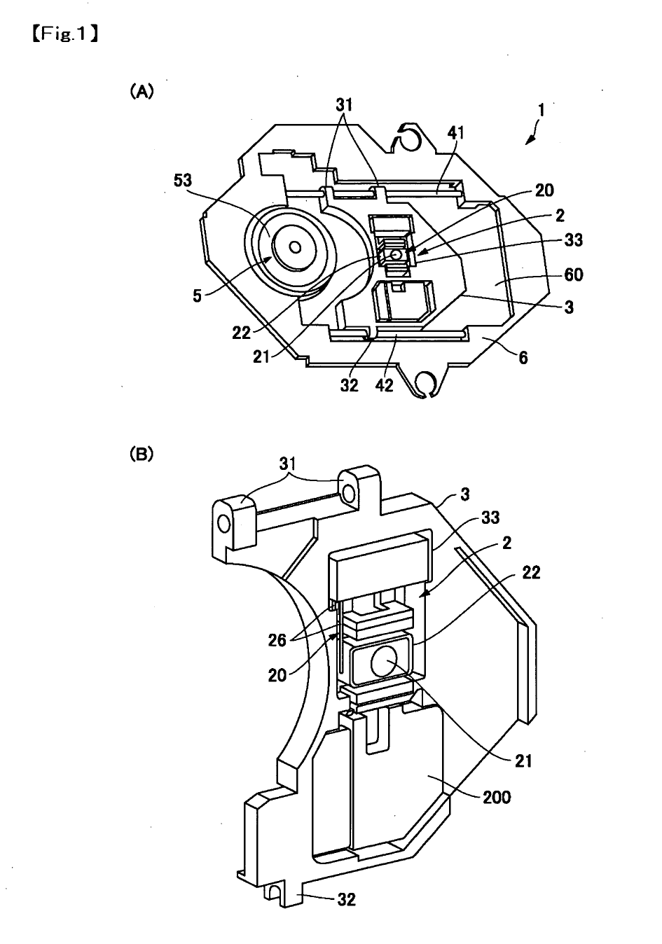

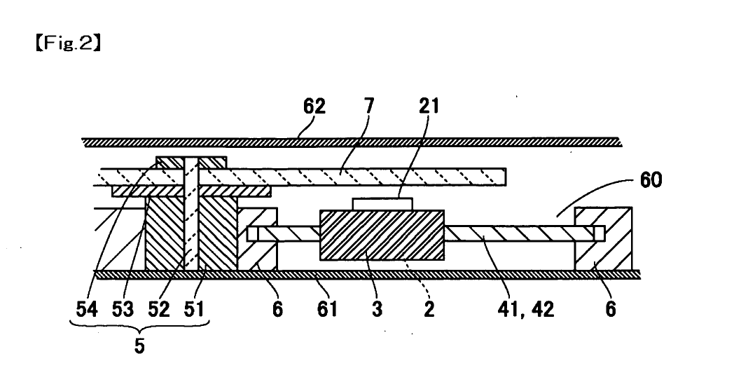

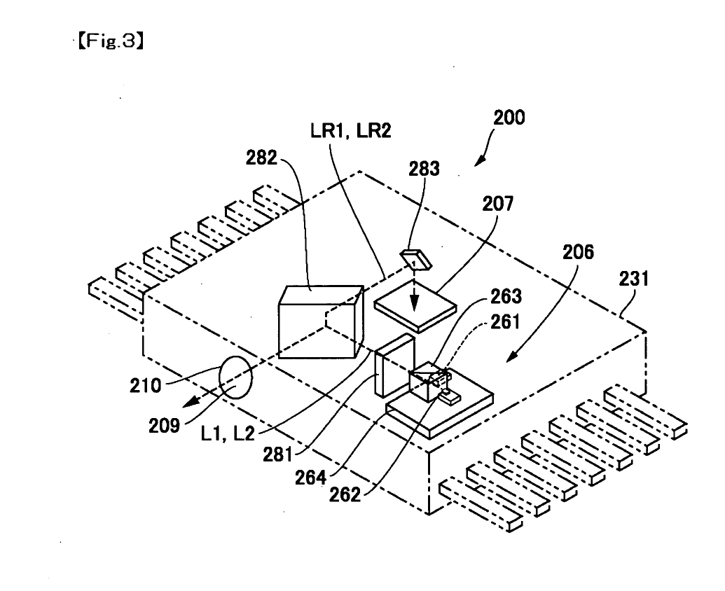

FIG. 1(A) is an explanatory perspective view showing an essential portion of an optical recording disk device in accordance with an embodiment of the present invention and FIG. 1(B) is an explanatory perspective view showing a frame on which an optical head mechanism is mounted in the optical recording disk device shown in FIG. 1(A). FIG. 2 is an explanatory view showing a schematic longitudinal cross section of the optical recording disk device shown in FIG. 1. FIG. 3 is an explanatory perspective view schematically showing an optical module that is used in the optical recording disk device shown in FIG. 1.

As shown in FIGS. 1(A) and 1(B) and FIG. 2, the optical recording disk device 1 to which the present invention is applied includes an optical head mechanism 2 provided with an optical system for converging an emitted light beam from a light source onto an optical recording disk 7, a frame 3 to which the optical head mechanism 2 is mounted, two guide shafts 41 and 42 for guiding the frame 3 in a radial direction of the optical recording disk 7, a disk drive mechanism 5 provided with a turntable 53 for holding the optical recording disk 7, and a chassis 6 having an aperture part 60 in which the frame 3, the two guide shafts 41, 42 and the disk drive mechanism 5 are provided. The frame 3, the two guide shafts 41, 42 and the disk drive mechanism 5 are disposed between an upper cover 62 and a lower cover 61 which cover the chassis 6 from the upper and lower sides.

The frame 3 is formed with bearing parts 31, 32 at both ends thereof for engaging with two guide shafts 41, 42 and provided at a central area of the frame 3 with an approximately rectangular aperture part 33 on which the optical head mechanism 2 is disposed.

The both ends of the guide shafts 41, 42 are held to the chassis 6. A male screw is formed on the guide shaft 41 (the main guide shaft of the two guide shafts 41, 42) and the bearing parts 31 are respectively formed with a female screw and thus the frame 3 is driven in a radial direction of the optical recording disk 7 by the rotation of the guide shaft 41.

In the embodiment of the present invention, an inclination adjustment mechanism for adjusting the parallelism between two guide shafts 41, 42 is constructed between one of two guide shafts 41, 42 and the chassis 6 and is not constructed between the other of two guide shafts 41, 42 and the chassis 6. Alternatively, no inclination adjustment mechanism may be constructed between both of the guide shafts 41, 42 and the chassis 6.

The optical head mechanism 2 includes a lens holder 22 holding an objective lens 21, an objective lens drive mechanism 20 of a wire suspension system which movably supports the lens holder 22 at least in the focusing and tracking directions with a plurality of wires 26, and an optical module 200. Also, the optical head mechanism 2 includes a magnetic-drive circuit (not shown) for driving the lens holder 22 in the focusing and the tracking directions.

The height dimension of the optical head mechanism 2 except the objective lens 21 is approximately equal to the thickness dimension of the frame 3. The optical head mechanism 2 is mounted in the aperture part 33 of the frame 3 so as to be completely contained within the aperture part 33.

The disk drive mechanism 5 includes a spindle motor 51, a turntable 53 fixed on the rotation shaft 52 of the spindle motor 51, and a disk chucking mechanism 54 mounted on the turntable 53. The disk drive mechanism 5 is mounted on the chassis 6 by fixing the spindle motor 51 on the chassis 6.

As shown in FIG. 3, the optical module 200 used in the optical head mechanism 2 is constructed such that a light source unit 206 and a light receiving element 207 for receiving a return light beam, which is the laser beam emitted from the light source unit 206 and reflected by the optical recording disk 7, are mounted within a package 231. A plurality of optical elements are disposed on the optical path of the laser beam emitted from the light source unit 206 to the outside of the optical module 200, and disposed on the optical path of the return light beam which is incident from the outside of the optical module 200 to the light receiving element 207.

The light source unit 206 is a two-wavelength light source unit that is provided with first and second laser diode chips 261, 262 and a prism 263 for matching the optical axes of the laser diode chips 261, 262.

The first laser diode chip 261 emits a laser beam with the wavelength of 650 nm for a DVD and the second laser diode chip 262 emits a laser beam with the wavelength of 780 nm for a CD. The first and the second laser diode chips 261, 262 are respectively used in a state of a semiconductor chip (semiconductor element) in a small size, which is not enclosed in a package.

The first and the second laser diode chips 261, 262, which are respectively mounted on a sub-mount formed of a semiconductor substrate, are mounted on a heat sink 264. The first and the second laser diode chips 261, 262 are arranged in such a manner that the respective emitting faces of the first and the second laser diode chips 261, 262 are brought into contact with adjacent incident faces of the prism 263 mounted on the heat sink 264. Alternatively, the first and the second laser diode chips 261, 262 may be arranged in such a manner that the respective front faces of the sub-mount are brought into contact with the adjacent incident faces of the prism 263. Therefore, the first and the second laser diode chips 261, 262 and the prism 263 are aligned and thus the first and the second laser diode chips 261, 262 are aligned each other. Accordingly, the first and the second laser beams L1, L2 are emitted from the emitting face of the prism 263 in a state that both the optical axes are matched each other.

A grating 281, a half mirror 282 and a falling (bending down) mirror 283 are disposed in the optical path of the first and the second laser beams L1, L2 emitted from the prism 263 and the optical path of the return light beams LR1, LR2 reflected by the optical recording disk 7 and incident on the light receiving element 207. The grating 281 is a wavelength-selectivity hologram element for splitting only the laser beam with the wavelength of 780 nm emitted from the second laser diode chip 262 into three beams. The half mirror 282 reflects the laser beams emitted from the first and the second laser diode chips 261, 262 to emit from a laser emitting hole 210 formed in the side face of the package 231. Also, the half mirror 282 transmits the return light beam from the emitting hole 210 to guide to the falling mirror 283. The falling mirror 283 reflects the return light beam to the light receiving element 207. A collimating lens 209 is mounted on the laser emitting hole 210 provided on the side face of the package 231.

The optical module 200 is not provided with a raising mirror for bending the optical axis upward on the way to the objective lens 21 from the collimating lens 209. The raising mirror is directly mounted on the frame 3.

In the optical disk device 1 as constructed above, the laser beam emitted from the optical head mechanism 2 is required to be condensed and irradiated perpendicularly on the optical recording disk 7 held on the turntable 53. For this reason, according to the present invention, the following embodiments are adopted.

### First Embodiment

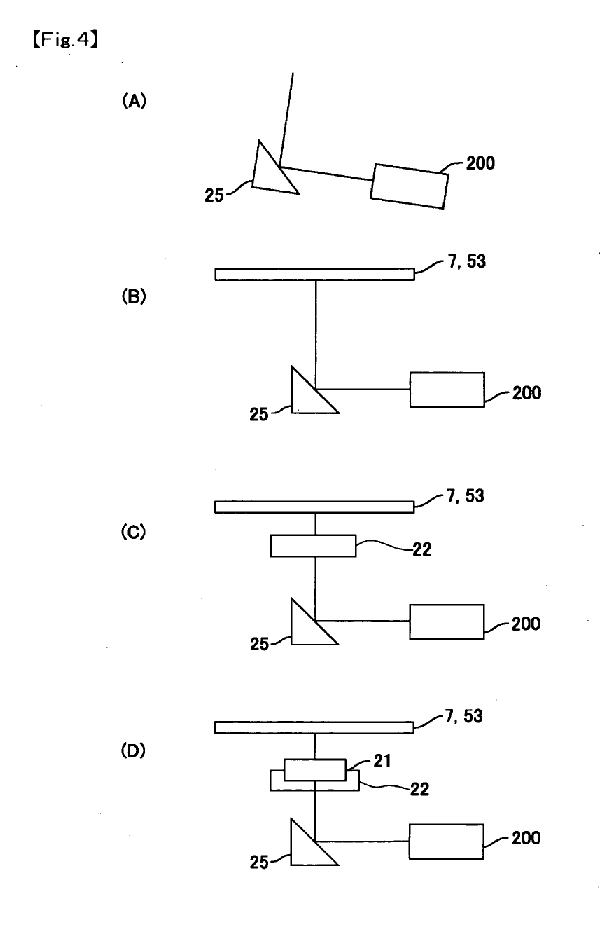

FIGS. 4(A) through 4(D) are explanatory views showing respective steps to perform the inclination adjustment of the optical head device with the turntable of the disk drive mechanism as a reference in a manufacturing method for the optical recording disk device in accordance with a first embodiment of the present invention.

In FIGS. 1(B) and 2, the optical recording disk device 1 of the first embodiment of the present invention is constructed such that the optical module 200 and the raising mirror of the optical head mechanism 2 are mounted to the frame 3 such that their inclinations are capable of being adjusted. On the other hand, two guide shafts 41, 42 are constructed such that their inclinations are unable to be adjusted with respect to the chassis 6, in other words, the inclinations of two guide shafts 41, 42 are fixed on the chassis 6.

In order to adjust the inclination of the optical axis of the laser beam with respect to the optical recording disk 7 in the manufacturing method of the optical recording disk device 1, first, the frame 3 is mounted to two guide shafts 41, 42 and the two guide shafts 41, 42 are fixed on the chassis 6. Alternatively, after the two guide shafts 41, 42 are fixed on the chassis 6, the frame 3 may be mounted on the two guide shafts 41, 42. The disk drive mechanism 5 is also mounted on the chassis 6.

Then, the inclination adjustment of the optical head mechanism 2 is performed with the turntable 53 of the disk drive mechanism 5 as a reference, which is mounted on the chassis 6. After then, the optical head mechanism 2 is fixed on the frame 3.

Concretely, as shown in FIG. 4(A), first, the raising mirror 25 and the optical module 200 are respectively supported on respective jigs (not shown) and the optimal positioning of the raising mirror 25 and the optimal positioning of the optical module 200 are performed. In addition, the optical axis of the laser beam emitted from the raising mirror 25 is adjusted so as to be in a vertical direction.

Next, as shown in FIG. 4(B), the jig supporting the raising mirror 25 is inclined such that the optical axis of the laser beam emitted from the raising mirror 25 is vertical with respect to the turntable 53 or the optical recording disk on the turntable 53. As described above, the inclination adjustments of the raising mirror 25 and the optical module 200 are performed.

Next, as shown in FIG. 4(C), an aperture diaphragm portion (lens holder 22) with respect to an objective lens 21 is adjusted.

Next, as shown in FIG. 4(D), the objective lens 21 is adhesively fixed on the lens holder 22 and the inclination adjustment of the objective lens 21 is performed with the turntable 53 or the optical recording disk 7 on the turntable 53 as the reference. Also, the raising mirror 25 and the optical module 200 are adhesively bonded and fixed on the frame 3.

In the first embodiment of the present invention, as described above, after the disk drive mechanism 5 is mounted on the chassis 6, the inclination adjustment of the optical head mechanism 2 is performed with the turntable 53 as the reference. Then, the optical head mechanism 2 is mounted on the frame 3 that is carried on two guide shafts 41, 42, which are mounted on the chassis 6. Therefore, the inclination of the optical axis of the laser beam emitted from the optical head mechanism 2 with respect to the turntable 53 or the optical recording disk 7 on the turntable 53 is directly adjusted and thus the inclination adjustment of the two guide shafts 41, 42 are not required. Accordingly, a wide clearance is not required between the lower cover 61 and the frame 3 to ensure the displacement of the frame 3 when the inclinations of two guide shafts 41, 42 are adjusted as with the conventional method. Consequently, the thickness of the optical recording disk device 1 is reduced. Also, the chassis 6 is not required to be provided with an inclination adjustment mechanism for two guide shafts 41, 42 in the optical axis direction toward the optical recording disk and thus the construction of the chassis 6 can be simplified.

### Second Embodiment

In FIGS. 1(A) and 2, the optical recording disk device 1 in accordance with the second embodiment of the present invention is constructed such that the disk drive mechanism 5 is mounted on the chassis 6 in the state that the inclination of the disk drive mechanism 5 has been adjusted. Two guide shafts 41, 42 are constructed such that the guide shafts 41, 42 are unable to perform the inclination adjustment with respect to the chassis 6, in other words, the inclinations of the guide shafts 41, 42 are fixed with respect to the chassis 6.

In order to adjust the inclination of the optical axis of the laser beam with respect to the optical recording disk 7 in the manufacturing method of the optical recording disk device 1, first, the frame 3 is mounted to two guide shafts 41, 42 and the two guide shafts 41, 42 are fixed to the chassis 6. Alternatively, after the two guide shafts 41, 42 are fixed on the chassis 6, the frame 3 may be mounted on the two guide shafts 41, 42.

Next, the optical head mechanism 2 is mounted to the frame 3 that is carried on the two guide shafts 41, 42, which are fixed to the chassis 6.

Next, the inclination adjustment of the turntable 53 or the optical recording disk 7 on the turntable 53 in the disk drive mechanism 5 is performed with the optical axis of the laser beam emitted from the optical head mechanism 2 as the reference, and then the spindle motor 51 of the disk drive mechanism 5 is fixed on the chassis 6.

In the second embodiment of the present invention, as described above, after the optical head mechanism 2 is mounted on two guide shafts 41, 42 through the frame 3, the inclination adjustment of the disk drive mechanism 5 is performed with the optical head mechanism 2 as the reference and then the disk drive mechanism 5 is mounted on the chassis 6. Therefore, the inclination of the optical axis of the laser beam emitted from the optical head mechanism 2 with respect to the turntable 53 or the optical recording disk 7 on the turntable 53 is directly adjusted and thus the inclination adjustment of the two guide shafts 41, 42 are not required. Accordingly, a wide clearance is not required between the lower cover 61 and the frame 3 to ensure the displacement of the frame 3 when the inclinations of the two guide shafts 41, 42 are adjusted as with the conventional method. Consequently, the thickness of the optical recording disk device 1 is reduced. Also, the chassis 6 is not required to be provided with an inclination adjustment mechanism for the two guide shafts 41, 42 in the optical axis direction toward the optical recording disk and thus the construction of the chassis 6 can be simplified.

### Third Embodiment

In FIGS. 1(A) and 2, the optical recording disk device 1 in accordance with the third embodiment of the present invention is constructed such that the optical head mechanism 2 is mounted on the frame 3 in the state that the inclination of the optical head mechanism 2 has been adjusted and the disk drive mechanism 5 is mounted on the chassis 6 in the state that the inclination of the disk drive mechanism 5 has been adjusted. Two guide shafts 41, 42 are constructed such that the guide shafts 41, 42 are unable to perform the inclination adjustment with respect to the chassis 6, in other words, the inclinations of the guide shafts 41, 42 are fixed with respect to the chassis 6.

In order to adjust the inclination of the optical axis of the laser beam with respect to the optical recording disk 7 in the manufacturing method of the optical recording disk device 1, first, the frame 3 is mounted on two guide shafts 41, 42 and the two guide shafts 41, 42 are fixed on the chassis 6. Alternatively, after the two guide shafts 41, 42 are fixed on the chassis 6, the frame 3 may be mounted on the two guide shafts 41, 42.

The inclination adjustment of the disk drive mechanism 5 is performed with two guide shafts 41, 42 as the reference and then the disk drive mechanism 5 is mounted to the chassis 6.

Next, as described in the first embodiment 1 with reference to FIG. 4, the inclination adjustment of the optical head mechanism 2 is performed with the turntable 53 as the reference and then the optical head mechanism 2 is mounted on the frame 3.

Alternatively, the inclination adjustment of the optical head mechanism 2 may be performed with two guide shafts 41, 42 as the reference and then the optical head mechanism 2 is mounted on the frame 3.

As described above, in the third embodiment of the present invention, the inclination adjustment of the disk drive mechanism 5 is performed with two guide shaft 41, 42 as the reference and then the disk drive mechanism 5 is mounted on the chassis 6. Therefore, even when the inclination adjustment of the optical head mechanism 2 is performed with either the turntable 53 or two guide shafts 41, 42 as the reference, the inclination of the optical axis of the laser beam emitted from the optical head mechanism 2 can be adjusted with respect to the turntable 53 or the optical recording disk 7 on the turntable 53. Accordingly, the inclination adjustment of the two guide shafts 41, 42 are not required. As a result, a wide clearance is not required between the lower cover 61 and the frame 3 to ensure the displacement of the frame 3 when the inclinations of the two guide shafts 41, 42 are adjusted as with the conventional method. Consequently, the thickness of the optical recording disk device 1 is reduced. Also, the chassis 6 is not required to be provided with an inclination adjustment mechanism for the two guide shafts 41, 42 in the optical axis direction toward the optical recording disk and thus the construction of the chassis 6 can be simplified.

### Fourth Embodiment

In FIGS. 1(A) and 2, the optical recording disk device 1 in accordance with the fourth embodiment of the present invention is constructed such that the optical head mechanism 2 is mounted to the frame 3 in the state that the inclination of the optical head mechanism 2 has been adjusted and the disk drive mechanism 5 is mounted to the chassis 6 in the state that the inclination of the disk drive mechanism 5 has been adjusted. Two guide shafts 41, 42 are constructed such that the guide shafts 41, 42 are unable to perform the inclination adjustment with respect to the chassis 6, in other words, the inclinations of the guide shafts 41, 42 are fixed with respect to the chassis 6.

In order to adjust the inclination of the optical axis of the laser beam with respect to the optical recording disk 7 in the manufacturing method of the optical recording disk device 1, first, the frame 3 is mounted to two guide shafts 41, 42 and the two guide shafts 41, 42 are fixed to the chassis 6. Alternatively, after the two guide shafts 41, 42 are fixed to the chassis 6, the frame 3 may be mounted to the two guide shafts 41, 42.

The inclination adjustment of the optical head mechanism 2 is performed with the two guide shafts 41, 42 as the reference and then the optical head mechanism 2 is mounted to the frame 3.

Next, as similar to the second embodiment, the inclination adjustment of the disk drive mechanism 5 is performed with the optical head mechanism 2 as the reference and then the disk drive mechanism 5 is mounted to the chassis 6.

Alternatively, the inclination adjustment of the disk drive mechanism 5 is performed with two guide shaft 41, 42 as the reference and then the disk drive mechanism 5 is mounted on the chassis 6.

As described above, in the fourth embodiment of the present invention, the inclination adjustment of the optical head mechanism 2 is performed with two guide shafts 41, 42 as the reference and then the optical head mechanism 2 is mounted on the frame 3. Therefore, even when the inclination adjustment of the disk drive mechanism 5 is performed with either the two guide shafts 41, 42 or the optical head mechanism 2 as the reference, the inclination of the optical axis of the laser beam emitted from the optical head mechanism 2 can be adjusted with respect to the turntable 53 or the optical recording disk 7 on the turntable 53. Accordingly, the inclination adjustment of the two guide shafts 41, 42 are not required. As a result, a wide clearance is not required between the lower cover 61 and the frame 3 to ensure the displacement of the frame 3 when the inclinations of the two guide shafts 41, 42 are adjusted as with the conventional method. Consequently, the thickness of the optical recording disk device 1 is reduced. Also, the chassis 6 is not required to be provided with an inclination adjustment mechanism for the two guide shafts 41, 42 in the optical axis direction toward the optical recording disk and thus the construction of the chassis 6 can be simplified.

As described above, according to the optical recording disk device of the present invention, the inclination of the optical axis of a laser beam emitted from the optical head mechanism can be adjusted with respect to the optical recording disk that rotates on the turntable without adjusting the inclinations of the two guide shafts. Accordingly, a wide clearance is not required in order to ensure the displacement of the frame when the inclinations of the two guide shafts are adjusted as with the conventional method. Consequently, the thickness of the optical recording disk device is reduced. Also, the chassis is not required to be provided with an inclination adjustment mechanism for the two guide shafts in the optical axis direction toward the optical recording disk and thus the construction of the chassis can be simplified.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

1. An optical recording disk device comprising:
an optical head mechanism provided with an optical system for converging an emitted light beam from a light source on an optical recording disk;
a frame to which the optical head mechanism is mounted;
two guide shafts for guiding the frame in a radial direction of the optical recording disk;
a disk drive mechanism provided with a turntable for holding the optical recording disk; and
a chassis to which the frame, the two guide shafts and the disk drive mechanism are mounted,
wherein at least one of the two guide shafts is constructed such that the inclination of one of the two guide shafts is unable to be adjusted and fixed with respect to the chassis in an optical axis direction toward the optical recording disk.

2. The optical recording disk device according to claim 1, further comprising an objective lens drive mechanism of a wire suspension type provided in the optical head mechanism, and wherein the objective lens drive mechanism is provided with a lens holder which holds an objective lens and is movably supported by a plurality of wires in a focusing direction and a tracking direction.

3. The optical recording disk device according to claim 1, wherein a height dimension of the optical system excluding the objective lens is substantially equal to a thickness dimension of the frame.

4. The optical recording disk device according to claim 1, further comprising an optical module in which a plurality of optical elements constructing the optical system in the optical head mechanism are modularized.

5. A manufacturing method for an optical recording disk device, comprising:
providing an optical head mechanism which is provided with an optical system for converging an emitted light beam from a light source on an optical recording disk, a frame to which the optical head mechanism is mounted, two guide shafts for guiding the frame in a radial direction of the optical recording disk, a disk drive mechanism provided with a turntable on which the optical recording disk is held, and a chassis to which the frame, the two guide shafts and the disk drive mechanism are mounted;
mounting the disk drive mechanism to the chassis;
adjusting an inclination of the optical head mechanism with the turntable of the disk drive mechanism as a reference with respect to the frame mounted to the two guide shafts which are fixed to the chassis; and
mounting the optical head mechanism to the frame.

6. The manufacturing method for an optical recording disk device according to claim 5, further comprising:
modularizing some of a plurality of optical elements constructing the optical system in an optical module;
converging an emitted light beam from a light source on the optical recording disk from an objective lens;
bending an optical axis of a light beam from the optical module toward the objective lens by a raising mirror;
adjusting an inclination of the optical module, an inclination of the raising mirror and an inclination of the objective lens with the turntable as the reference; and
mounting the optical module, the raising mirror and the objective lens are respectively to the frame.

7. The manufacturing method for an optical recording disk device according to claim 6, further comprising:
adjusting the inclinations of the optical module and the raising mirror such that an optical axis from the raising mirror is vertical to the turntable; and
fixing the objective lens to a lens holder.

8. The manufacturing method for an optical recording disk device according to claim 6, wherein the optical module includes a light source unit, a light receiving element for receiving a return light beam, a grating, a half mirror and a collimating lens.

9. The manufacturing method for an optical recording disk device according to claim 5, further comprising:
adjusting an inclination of the disk drive mechanism with the guide shaft as a reference; and
mounting the disk drive mechanism to the chassis.

10. The manufacturing method for an optical recording disk device according to claim 5, further comprising:
mounting the frame to the two guide shafts; and
fixing the two guide shafts to the chassis.

11. A manufacturing method for an optical recording disk device, comprising:
providing an optical head mechanism which is provided with an optical system for converging an emitted light beam from a light source on an optical recording disk, a frame to which the optical head mechanism is mounted, two guide shafts for guiding the frame in a radial direction of the optical recording disk, a disk drive mechanism provided with a turntable on which the optical recording disk is held, and a chassis to which the frame, the two guide shafts and the disk drive mechanism are mounted;
fixing the two guide shafts to the chassis;
mounting the optical head mechanism to the frame which is mounted to the two guide shafts;
adjusting an inclination of the disk drive mechanism with the optical head mechanism as a reference; and
fixing the disk drive mechanism to the chassis.

12. A manufacturing method for an optical recording disk device comprising:
providing an optical head mechanism which is provided with an optical system for converging an emitted light beam from a light source on an optical recording disk, a frame to which the optical head mechanism is mounted, two guide shafts for guiding the frame in a radial direction of the optical recording disk, a disk drive mechanism provided with a turntable on which the optical recording disk is held, and a chassis to which the frame, the two guide shafts and the disk drive mechanism are mounted;
fixing the two guide shafts for mounting the frame to the chassis;
adjusting an inclination of the disk drive mechanism with the guide shaft as a reference and then mounting the disk drive mechanism to the chassis; and
adjusting an inclination of the optical head mechanism with the guide shaft as a reference and then mounting the optical head mechanism to the frame.

13. A manufacturing method for an optical recording disk device comprising:
providing an optical head mechanism which is provided with an optical system for converging an emitted light beam from a light source on an optical recording disk, a frame to which the optical head mechanism is mounted, two guide shafts for guiding the frame in a radial direction of the optical recording disk, a disk drive mechanism provided with a turntable on which the optical recording disk is held, and a chassis to which the frame, the two guide shafts and the disk drive mechanism are mounted;
fixing the two guide shafts for mounting the frame to the chassis;
adjusting an inclination of the optical head mechanism with the guide shaft as a reference and then mounting the optical head mechanism to the frame; and
adjusting an inclination of the disk drive mechanism with one of the optical head mechanism and the guide shaft as a reference and then mounting the disk drive mechanism to the chassis.

14. The manufacturing method for an optical recording disk device according to claim 11, wherein the optical head mechanism comprising:
modularizing some of a plurality of optical elements constructing the optical system in an optical module;
converging an emitted light beam from a light source on the optical recording disk from an objective lens;
bending an optical axis of a light beam from the optical module toward the objective lens by a raising mirror;
adjusting an inclination of the optical module, an inclination of the raising mirror and an inclination of the objective lens with the turntable as the reference; and
mounting the optical module, the raising mirror and the objective lens are respectively to the frame.

15. The manufacturing method for an optical recording disk device according to claim 12, wherein the optical head mechanism comprising:
modularizing some of a plurality of optical elements constructing the optical system in an optical module;
converging an emitted light beam from a light source on the optical recording disk from an objective lens;
bending an optical axis of a light beam from the optical module toward the objective lens by a raising mirror;
adjusting an inclination of the optical module, an inclination of the raising mirror and an inclination of the objective lens with the turntable as the reference; and
mounting the optical module, the raising mirror and the objective lens are respectively to the frame.

16. The manufacturing method for an optical recording disk device according to claim 13, wherein the optical head mechanism comprising:
modularizing some of a plurality of optical elements constructing the optical system in an optical module;
converging an emitted light beam from a light source on the optical recording disk from an objective lens;
bending an optical axis of a light beam from the optical module toward the objective lens by a raising mirror;
adjusting an inclination of the optical module, an inclination of the raising mirror and an inclination of the objective lens with the turntable as the reference; and
mounting the optical module, the raising mirror and the objective lens are respectively to the frame.

17. The manufacturing method for an optical recording disk device according to claim 14, further comprising:
adjusting the inclinations of the optical module and the raising mirror such that an optical axis from the raising mirror is vertical to the turntable; and
fixing the objective lens to a lens holder.

18. The manufacturing method for an optical recording disk device according to claim 15, further comprising:
adjusting the inclinations of the optical module and the raising mirror such that an optical axis from the raising mirror is vertical to the turntable; and
fixing the objective lens to a lens holder.

19. The manufacturing method for an optical recording disk device according to claim 16, further comprising:
adjusting the inclinations of the optical module and the raising mirror such that an optical axis from the raising mirror is vertical to the turntable; and
fixing the objective lens to a lens holder.

20. The manufacturing method for an optical recording disk device according to claim 14, wherein the optical module includes a light source unit, a light receiving element for receiving a return light beam, a grating, a half mirror and a collimating lens.
